(19) United States
(12) Patent Application Publication
(10) Pub. No.: US 2018/0267749 A1
(43) Pub. Date: Sep. 20, 2018

(54) PRINTING APPARATUS

(71) Applicant: SEIKO EPSON CORPORATION, Tokyo (JP)

(72) Inventor: Yutaka YOSHIDA, Matsumoto-shi (JP)

(73) Assignee: SEIKO EPSON CORPORATION, Tokyo (JP)

(21) Appl. No.: 15/921,305

(22) Filed: Mar. 14, 2018

(30) Foreign Application Priority Data
Mar. 16, 2017 (JP) 2017-051772
Nov. 17, 2017 (JP) 2017-221644

(51) Int. Cl. G06F 3/12

(52) U.S. Cl. CPC G06F 3/1212; G06F 3/1294; G06F 3/1292

(57) ABSTRACT

A printing apparatus, which performs wireless communication with an information terminal, includes a communication control unit that receives second data when detecting transmission of the second data included in a second data group from a second information terminal after receiving first data included in a first data group from a first information terminal and before receiving an execution request of predetermined processing from the first information terminal, and a processing execution unit that executes the predetermined processing based on the second data when the communication control unit receives an execution request of the predetermined processing from the second information terminal after receiving the second data and before receiving data from an information terminal other than the second information terminal.

### BACKGROUND

### 1. Technical Field

The present invention relates to a printing apparatus.

### 2. Related Art

An information terminal transmits data to a printer and the printer performs printing on the basis of the transmitted data.

Processing is disclosed where one file is divided into a plurality of divided data (packet data) and transmitted from a communication terminal apparatus to an MFP (see JP-A-2014-194594).

When an information terminal transmits a large amount of data to a printer at once, the printer is occupied by the information terminal, so that another information terminal may be forced to wait until starting communication with the printer. Here, as in JP-A-2014-194594, when divided data is transmitted to a printer from an information terminal, if divided data is transmitted to the printer from each of a plurality of transmission sources of information terminals, the reception side printer may mix up the divided data transmitted from the plurality of information terminals, so that there is a possibility that the printer cannot perform appropriate processing corresponding to each information terminal. Further, in an environment where divided data can be transmitted to the printer from each of a plurality of transmission sources of information terminals, when data transmission from an information terminal is interrupted due to cause on the side of the information terminal, the printer may not be able to appropriately switch to a state for receiving data from another information terminal, and communication between the other information terminal and the printer may be delayed.

### SUMMARY

An advantage of some aspects of the invention is to provide a printing apparatus effective for at least one of the problems described above.

One of some aspects of the invention is a printing apparatus that performs wireless communication with an information terminal. The printing apparatus includes a communication control unit that receives second data when detecting transmission of the second data included in a second data group from a second information terminal after receiving first data included in a first data group from a first information terminal and before receiving an execution request of predetermined processing from the first information terminal, and a processing execution unit that executes the predetermined processing based on the second data when the communication control unit receives an execution request of the predetermined processing from the second information terminal after receiving the second data and before receiving data from an information terminal other than the second information terminal.

According to the above configuration, in an environment where each of a plurality of information terminals can perform data transmission to the printing apparatus, when transmission of the second data included in the second data group is performed from the second information terminal before transmission of the first data included in the first data group from the first information terminal is completely ended, if, thereafter, the printing apparatus can receive the execution request from the second information terminal before receiving data from an information terminal other than the second information terminal, the printing apparatus executes the predetermined processing based on the second data. Thereby, when data transmission from an information terminal (the first information terminal) is stopped or interrupted, data transmission from another information terminal (the second information terminal) is received by the printing apparatus without delay, and the predetermined processing is smoothly advanced.

One of some modes of the invention may be a printing apparatus in which the processing execution unit executes the predetermined processing based on the first data when the communication control unit does not receive the second data from the second information terminal after receiving the first data from the first information terminal and before receiving the execution request from the first information terminal, and the processing execution unit does not execute the predetermined processing based on the first data when the communication control unit receives the second data from the second information terminal after receiving the first data from the first information terminal and before receiving the execution request from the first information terminal.

According to the above configuration, the printing apparatus can avoid mix-up between data received from different transmission sources and confusion of predetermined processing based on data received from different transmission sources, so that the printing apparatus can appropriately perform predetermined processing corresponding to one transmission source.

Further, the invention as described above may be grasped as a configuration of a printing apparatus that performs wireless communication with an information terminal. The printing apparatus includes a communication control unit that receives first data when the first data included in a first data group is transmitted from a first information terminal and receives second data when the second data included in a second data group is transmitted from a second information terminal, and a processing execution unit that can execute predetermined processing based on data received by the communication control unit according to an execution request of the predetermined processing received by the communication control unit. The processing execution unit executes the predetermined processing based on the first data when the communication control unit receives the execution request from the first information terminal after receiving the first data from the first information terminal and before receiving data from an information terminal other than the first information terminal, and does not execute the predetermined processing based on the first data when the communication control unit receives the second data from the second information terminal after receiving the first data from the first information terminal and before receiving the execution request from the first information terminal, and thereafter executes the predetermined processing based on the second data when the communication control unit receives the execution request from the second information terminal before receiving data from an information terminal other than the second information terminal.

One of some modes of the invention may be a printing apparatus in which the communication control unit receives data that specifies an electronic file stored in a storage apparatus connected to the printing apparatus as each of the first data and the second data.

According to the above configuration, the printing apparatus can obtain specification of an electronic file stored in a storage apparatus connected to the printing apparatus from an external information terminal.

One of some modes of the invention may be a printing apparatus in which the execution request of the predetermined processing is an execution request of printing processing, and the processing execution unit prints the electronic file specified by the second data when the communication control unit receives the execution request from the second information terminal after receiving the second data and before receiving data from an information terminal other than the second information terminal. In other words, the processing execution unit executes printing of the electronic file specified by the first data as the predetermined processing based on the first data and executes printing of the electronic file specified by the second data as the predetermined processing based on the second data.

According to the above configuration, the printing apparatus can smoothly perform printing of an electronic file specified by the second information terminal. Similarly, the printing apparatus can smoothly perform printing of an electronic file specified by the first information terminal.

One of some modes of the invention may be a printing apparatus in which when the communication control unit receives data from the information terminal, the communication control unit issues identification information for identifying a transmission source of the data to the information terminal of the transmission source and invalidates identification information that has been issued to another information terminal to identify the other information terminal, and when the processing execution unit receives the execution request from the information terminal having the identification information that is not invalidated, the processing execution unit executes the predetermined processing based on data that has been received from the information terminal having the identification information that is not invalidated.

According to the above configuration, the printing apparatus performs the predetermined processing on the basis of the data received from the information terminal having the identification information that is not invalidated. Thereby, it is possible to avoid confusion of processing based on data received from different transmission sources and appropriately perform predetermined processing corresponding to one transmission source having currently valid identification information.

One of some modes of the invention may be a printing apparatus in which the processing execution unit executes the predetermined processing based on data that has been received from the information terminal having the identification information that is not invalidated, and accordingly, the communication control unit invalidates the identification information.

According to the above configuration, the printing apparatus restores the state where there is no valid identification information, and waits for data transmission from the information terminal again.

One of some modes of the invention may be a printing apparatus in which when the communication control unit receives the second data from the second information terminal after receiving the first data from the first information terminal and before receiving the execution request from the first information terminal, the processing execution unit discards the first data.

According to the above configuration, it is possible to reduce consumption of memory resources in the printing apparatus by discarding data that can be said to once become useless.

One of some modes of the invention may be a printing apparatus in which after discarding the first data, the communication control unit causes the first information terminal to execute at least either one of a screen display indicating that the first data is discarded and a screen display that prompts retransmission of the first data by transmitting a predetermined screen display instruction to the first information terminal.

According to the above configuration, it is possible to notify a user of the first information terminal that the first data is discarded and/or prompt the user to retransmit the first data.

One of some modes of the invention may be a printing apparatus in which after the processing execution unit executes the predetermined processing based on the second data, the communication control unit causes the first information terminal to execute retransmission of the first data by transmitting a retransmission instruction of the first data to the first information terminal.

According to the above configuration, transmission of the first data from the first information terminal is automatically started after the processing execution unit executes the predetermined processing based on the second data, so that the printing apparatus can finally execute predetermined processing based on data transmitted from the first information terminal.

One of some aspects of the invention is a printing apparatus that performs wireless communication with an information terminal. The printing apparatus includes a communication control unit that receives first data when the first data included in a first data group is transmitted from a first information terminal and receives second data when the second data included in a second data group is transmitted from a second information terminal, a data holding unit that holds the first data, which the communication control unit receives from the first information terminal, in association with the first information terminal, and holds the second data, which the communication control unit receives from the second information terminal, in association with the second information terminal, and a processing execution unit that can execute predetermined processing based on data held by the data holding unit. The processing execution unit executes the predetermined processing based on data held in association with an information terminal in order from the information terminal that has transmitted all data included in a data group.

According to the above configuration, in an environment where each of a plurality of information terminals can perform data transmission to the printing apparatus, the printing apparatus receives each of the transmission of the first data included in the first data group from the first information terminal and the transmission of the second data included in the second data group from the second information terminal, and holds the received data in association with the transmission sources. Then, the printing apparatus executes predetermined processing based on data held in association with information terminals in order from the information terminal that has transmitted all data included in the data group. Thereby, when data transmission from an information terminal is stopped or interrupted, data transmission from another information terminal is received by the printing apparatus without delay, and the predetermined processing is smoothly advanced. In addition, when data transmission from an information terminal whose data transmission is stopped or interrupted is resumed, it is possible to smoothly execute predetermined processing based on data from the information terminal whose data transmission is resumed. Further, it is possible to avoid mix-up between data received from different transmission sources and confusion of predetermined processing based on data received from different transmission sources.

One of some modes of the invention may be a printing apparatus in which when a predetermined condition is established, the data holding unit causes a storage apparatus connected to the printing apparatus to store at least a part of the data held by the data holding unit.

According to the above configuration, even when the printing apparatus receives a large amount of data from an information terminal, the printing apparatus can hold the received data in the printing apparatus (the data holding unit) and a storage apparatus connected to the printing apparatus in a distributed manner.

As a specific example, the data holding unit may determine that the predetermined condition is established when a total data size of data which the communication control unit receives from an information terminal exceeds a predetermined threshold value related to a storage capacity of the data holding unit or when the number of information terminals that are continuing transmission processing of each data included in a data group exceeds a predetermined threshold value related to the number of information terminals.

According to the above configuration, the printing apparatus avoids in advance a situation where the data holding unit cannot hold any more data transmitted from an information terminal, and can hold data in the printing apparatus (the data holding unit) and a storage apparatus connected to the printing apparatus in a distributed manner.

A technical idea of the invention is realized in various aspects other than a category of apparatus. For example, an invention of a method including steps realized by components of the printing apparatus, and an invention of a program that causes hardware (a computer) to perform such a method are established.

Further, a system including the information terminal and the printing apparatus is also established as an invention. As an example, it is possible to grasp a configuration of a communication system including information terminals and a printing apparatus which perform wireless communication. Specifically, the communication system includes a first information terminal that transmits first data included in a first data group to the printing apparatus, a second information terminal that transits second data included in a second data group to the printing apparatus after the transmission performed by the first information terminal, and the printing apparatus including a communication control unit that receives the second data when detecting transmission of the second data after receiving the first data and before receiving an execution request of predetermined processing from the first information terminal, and a processing execution unit that executes the predetermined processing based on the second data when the communication control unit receives an execution request of the predetermined processing from the second information terminal after receiving the second data and before receiving data from an information terminal other than the second information terminal.

Further, an invention of each category such as an information terminal, steps (method) performed by an information terminal, and a program that causes an information terminal to execute processing is also established. As an example, it is possible to grasp a configuration of a communication control program that causes an information terminal to perform communication. Specifically, the communication control program performs a selection receiving function that receives selection of a plurality of electronic files and a communication function that transmits a plurality of file paths respectively indicating storage locations of the plurality of selected files to a printing apparatus. The communication function divides the plurality of file paths into a plurality of groups and transmits one group of file paths to the printing apparatus for each communication in a plurality times of communication.

Further, an invention of a computer-readable storage medium that stores a program is established.

### BRIEF DESCRIPTION OF THE DRAWINGS

The invention will be described with reference to the accompanying drawings, wherein like numbers reference like elements.

FIG. 1 is a diagram simply showing an apparatus configuration.

FIG. 2 is a diagram showing a file selection screen.

FIG. 3 is a flowchart showing wireless printing processing.

FIG. 4 is a diagram for explaining a specific example of the wireless printing processing.

FIG. 5A is a diagram showing an example of an alert screen, and FIG. 5B is a diagram showing another example of the alert screen.

FIG. 6 is a flowchart showing wireless printing processing according to a second embodiment.

### DESCRIPTION OF EXEMPLARY EMBODIMENTS

Hereinafter, embodiments of the invention will be described with reference to the drawings. Each drawing is only an illustration for explaining the embodiments.

### 1. General Explanation of System

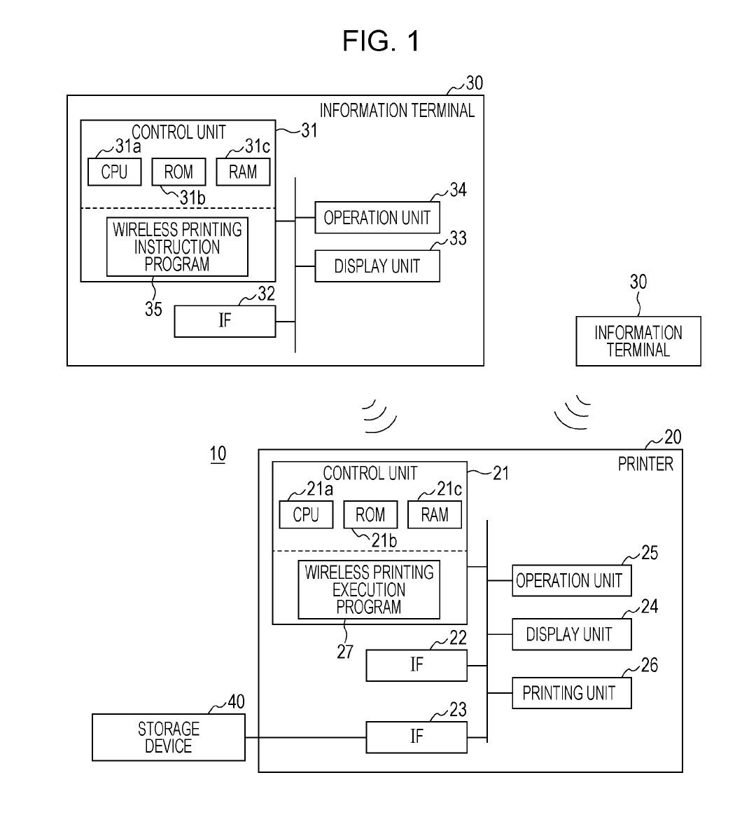

FIG. 1 simply shows a configuration of a system 100 according to an embodiment. The system 10 may be called a printing system, a communication system, or the like. The system 10 includes a printer 20 as a printing apparatus and a plurality of information terminals 30. The printer 20 is an apparatus that functions as at least a printer. The printer 20 may be a complex machine having also a plurality of functions such as a scanner and a facsimile. The printer 20 may be a stationary printer or may be a small portable printer (a mobile printer). The printer 20 may be called an image forming apparatus.

The printer 20 includes, for example, a control unit 21, interfaces (IFs) 22 and 23, a display unit 24, an operation unit 25, a printing unit 26, and the like. The control unit 21 includes, for example, one or a plurality of ICs having a CPU 21a, a ROM 21b, a RAM21c, and the like, and the other memory and the like. In the control unit 21, the CPU 21a controls behavior of each unit of the printer 20 such as the printing unit 26 by performing arithmetic processing according to firmware and a program stored in the ROM 21b or the like by using the RAM 21c or the like as a work area. In the control unit 21, a wireless printing execution program 27 is installed as a kind of program.

The IF 22 is an IF for performing wireless communication with an external wireless communication apparatus (the information terminal 30 or the like). In the present embodiment, a standard of the wireless communication is not particularly limited and various communication standards can be employed. The IF 22 is connected to, for example, an access point not shown in the drawings or a wireless LAN (Local Area Network) managed by a router, so that the IF 22 performs wireless communication with an external wireless communication apparatus through the access point or the like. Alternatively, the IF 22 may perform direct wireless communication with an external wireless communication apparatus without through an access point or the like. In this case, for example, the IF 22 itself functions as an access point.

The IF 23 is an IF for wiredly or directly connecting to an external apparatus. The IF 23 is, for example, a memory slot into which a storage device 40 is directly inserted or a port to which a communication cable connected to the storage device 40 is connected. Of course, the printer 20 can have a plurality of IFs 23, and besides the storage device 40, various devices such as a personal computer (PC) and a digital still camera, which are not shown in the drawings, can be wiredly connected to the IFs 23. There are various kinds of storage device 40 connected to the IF 23. Examples of the storage device 40 include a memory card such as an SD card, a USB memory, a hard disk drive (HDD), an optical disk, and a memory with a stick shape. The storage device 40 stores a plurality of electronic files, for example, a plurality of image files.

The display unit 24 is a means for displaying visual information. The display unit 24 is constituted of, for example, a liquid crystal display (LCD) or an organic EL display. The display unit 24 may have a configuration including a display and a drive circuit for driving the display. The operation unit 25 is a means for inputting an operation performed by a user and is realized by, for example, a touch panel, physical buttons, or a keyboard. Of course, the display unit can function as such a touch panel. The display unit 24 and the operation unit 25 can be collectively called an operation panel.

The printing unit 26 is a mechanism that performs printing based on print data. For example, the printing unit 26 performs printing by using an ink jet method. The print method employed by the printing unit 26 is not limited to the ink jet method, but various methods such as an electrophotographic method can be employed. The configuration of the printing unit 25 is publicly known, so that detailed description thereof will be omitted.

The information terminal 30 is realized by, for example, a smartphone, a mobile telephone, a tablet terminal, a PC, or a terminal having a function similar to these. Each information terminal 30 includes, for example, a control unit 31, an IF 32, a display unit 33, and an operation unit 34. The control unit 31 includes, for example, one or a plurality of ICs having a CPU 31a, a ROM 31b, a RAM31c, and the like, and the other memory and the like. In the control unit 31, the CPU 31a controls behavior of the information terminal 30 by performing arithmetic processing according to a program stored in the ROM 31b or the like by using the RAM 31c or the like as a work area. In the control unit 31, a wireless printing instruction program 35 is installed as a kind of program (application). The wireless printing instruction program 35 corresponds to a communication control program of the invention.

The IF 32 is an IF for performing wireless communication with an external wireless communication apparatus (the printer 20 or the like). The aforementioned description related to the display unit 24 and the operation unit 25 can be applied to basic description of the display unit 33 and the operation unit 34. In the present embodiment, the communication between the information terminal 30 and the printer 20 is wireless communication through the IF 32 and the IF 22 unless otherwise noted.

### 2. Data Transmission from the Information Terminal 30 to the Printer 20

The user can start the wireless printing instruction program 35 and transmit data from the information terminal 30 to the printer 20 by operating the operation unit 34 of the information terminal 30.

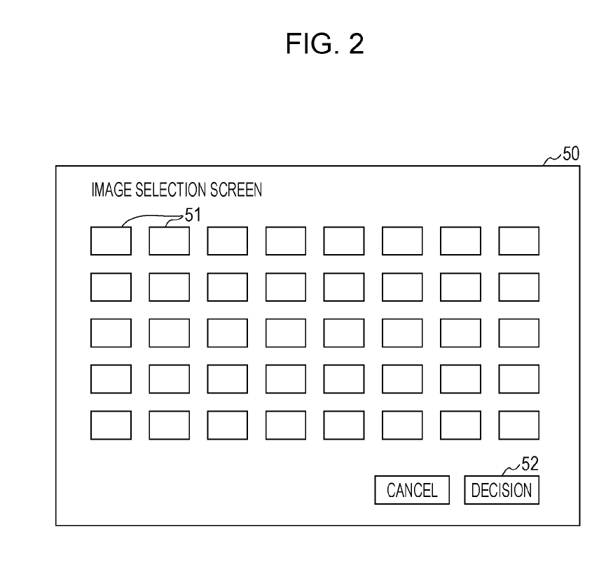

FIG. 2 shows an example of a file selection screen 50 which the control unit 31 of the information terminal 30 that performs processing according to the wireless printing instruction program 35 causes the display unit 33 to display. The control unit 31 (the wireless printing instruction program 35) acquires a reduced image (thumbnail) for each image file stored in the storage device 40 connected to the printer 20 from the printer 20 by communicating with the printer 20 and displays the plurality of acquired thumbnails in the file selection screen 50. In FIG. 2, each rectangle in the file selection screen 50 shows a thumbnail 51.

The user arbitrarily selects an image (thumbnail 51) which the user wants to print from among the plurality of thumbnails 51 displayed in the file selection screen 50 by operating the operation unit 34. The user operates, for example, a decision button 52 displayed in the file selection screen 50 in a state where the user selects one or more thumbnails 51. When the decision button 52 is operated, the control unit 31 receives a current selection state of the thumbnails 51. In other words, the wireless printing instruction program 35 causes the control unit 31 to realize a selection receiving function that receives a selection of a plurality of electronic files.

Next, the control unit 31 transmits a path (a file path) indicating a storage location (a folder or the like in the storage device 40) of each image file corresponding to a thumbnail 51 whose selection is received to the printer 20. It is assumed that when the control unit 31 acquires the thumbnail 51 for each image file stored in the storage device 40 from the printer 20 as described above, the control unit 31 also acquires file path information for each image file stored in the storage device 40. Such a file path corresponds to data that specifies an electronic file stored in a storage apparatus connected to the printer 20.

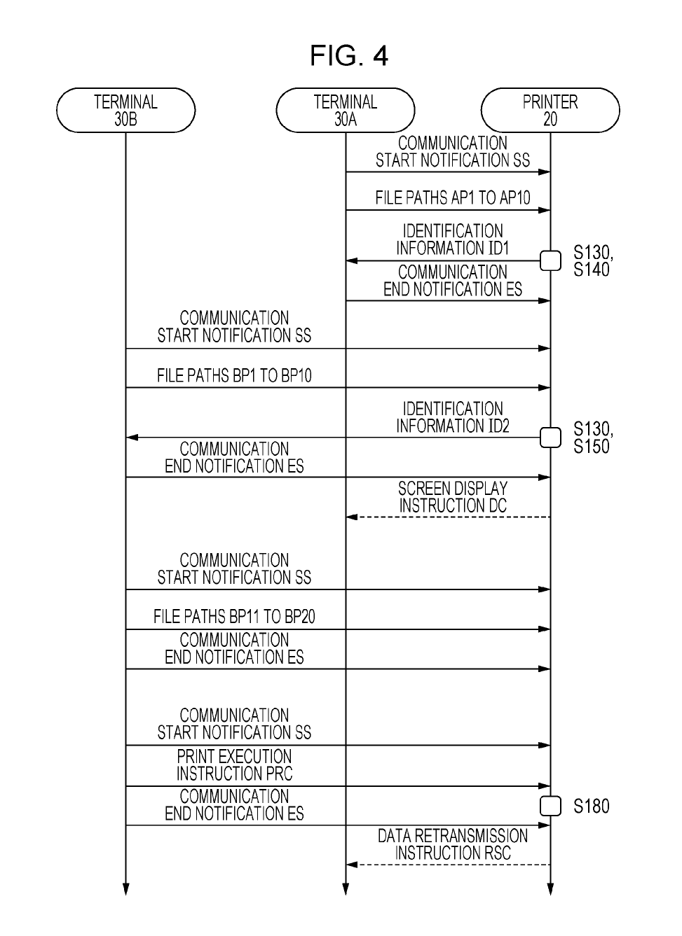

For example, the user can select hundreds of thumbnails 51 at a time in the file selection screen 50. The control unit 31 may transmit file paths of hundreds of image files corresponding to each thumbnail 51 selected in this way to the printer 20 at one-time communication. However, in the present embodiment, the information terminal 30 transmits a plurality of file paths by a plurality of times of communication. A specific example of the transmission of file paths by a plurality of times of communication will be described later with reference to FIG. 4 and the like. In any case, it can be said that the wireless printing instruction program 35 causes the control unit 31 to realize a communication function that divides a plurality of file paths indicating storage locations of each of a plurality of selected electronic files into a plurality of groups and transmits file paths of one group for each communication in a plurality times of communication to the printer 20.

### 3. Wireless Printing Processing

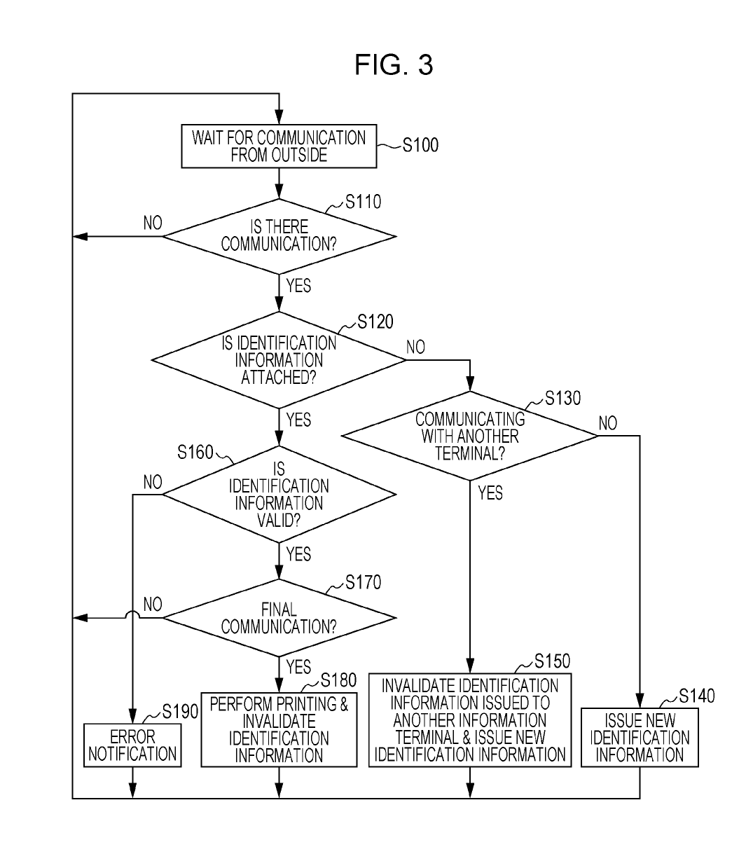

FIG. 3 shows wireless printing processing, which the control unit 21 of the printer 20 realizes according to the wireless printing execution program 27, by using a flowchart. The control unit 21 functions as a communication control unit and a processing execution unit by executing processing according to the wireless printing execution program 27.

The control unit 21 waits for wireless communication from outside (step S100). In such a state, the control unit 21 continuously determines whether or not the wireless communication from outside can be detected through the IF 22 (step S110), and when the wireless communication can be detected, that is, when there is the communication (“Yes” in step S110), the control unit 21 proceeds to step S120.

In step S120, the control unit 21 determines whether or not identification information for identifying a transmission source (the information terminal 30) of the communication is attached to the communication detected in step S110. Although described later in detail, when identification information is issued to the information terminal 30 from the printer 20, the information terminal 30 attaches the issued identification information of the information terminal 30 to communication to the printer 20. When no identification information is attached to the communication detected in step S110 (“No” in step S120), the control unit 21 proceeds to step S130.

In step S130, the control unit 21 branches processing depending on whether or not the control unit 21 is currently communicating with an information terminal 30 (another information terminal 30) other than the transmission source of the communication detected in step S110. The currently communicating with another information terminal 30 indicates a state in which currently valid identification information is issued to the other information terminal 30. The valid identification information is identification information that is not invalidated. When the control unit 21 is currently communicating with another information terminal 30 (“Yes” in step S130), the control unit 21 proceeds to step S150, and when the control unit 21 is not currently communicating with another information terminal 30 (“No” in step S130), the control unit 21 proceeds to step S140.

In step S140, the control unit 21 issues new identification information to the information terminal 30 of the transmission source of the communication detected in step S110. In other words, the control unit 21 generates new identification information and transmits the generated identification information to the information terminal 30 of the transmission source of the communication detected in step in S110. There are various methods for generating the identification information. The control unit 21 generates unique identification information by, for example, appropriately using or combining easily acquirable information such as information (serial number and the like) unique to the information terminal 30 of the transmission source of the communication detected in step in S110 and the current date and time, and a randomly generated random number. By step S140, a state switches from a state where there is no valid identification information to a state where there is valid identification information. After step S140, the control unit 21 returns to step S100.

On the other hand, in step S150, the control unit 21 invalidates the identification information that has been issued to the other information terminal 30 and has been valid, and issues new identification information to the information terminal 30 of the transmission source of the communication detected in step in S110. By step S150, the identification information that has been valid is invalidated and other valid identification information is generated. In other words, in the present embodiment, regarding the identification information issued by the printer 20 to identify the transmission source of wireless communication, a plurality of pieces of identification information do not become valid at the same time. After step S150, the control unit 21 returns to step S100.

FIG. 4 shows a specific example of the wireless printing processing. Hereinafter, the description is continued with reference to both FIGS. 3 and 4. FIG. 4 illustrates processing performed by each of a plurality of terminals 30A and 30B and the printer 20. Each of the terminals 30A and 30B is one information terminal 30. First, the terminal 30A transmits a communication start notification SS to the printer 20 and subsequently transmits file paths AP1 to AP10 to the printer 20. While the printer 20 waits for wireless communication from outside (step S100), the printer 20 can determine that there is the communication (“Yes” in step S110) when receiving (detecting) the communication start notification SS.

As an example, in the description of FIG. 4, the information terminal 30 (the terminal 30A or 30B) collectively transmits ten file paths by one-time communication to the printer 20. For example, when the terminal 30A receives selection of 200 thumbnails 51 from a user through the file selection screen 50, the terminal 30A divides 200 file paths for each image file corresponding to the 200 thumbnails into groups (a total of 20 groups) each of which includes 10 file paths, and transmits one group of file paths (for example, file paths AP1 to AP10) to the printer 20 by one-time communication. The one group of file paths corresponds to an example of first (or second) data included in a first (or second) data group (for example, 200 file paths) which the printer 20 receives from a first (or second) information terminal.

Although not particularly shown in FIG. 3, the printer 20 receives and stores data (file paths or the like) transmitted from the information terminal 30 following the communication start notification SS.

It is assumed that the identification information described above is not attached to the communication start notification SS and the file paths AP1 to AP10 transmitted from the terminal 30A to the printer 20. In this case, the control unit 21 determines “No” in step S120 and proceeds to step S130. In the description of FIG. 4, it is assumed that the printer 20 is not communicating with another information terminal 30 (that is, there is no valid identification information) when there is communication from the terminal 30A. Therefore, in this case, the control unit 21 determines “No” in step S130 and proceeds to step S140. In step S140, the control unit 21 generates new identification information (identification information ID1) and transmits this identification information ID1 to the terminal 30A.

The terminal 30A transmits a communication end notification ES to the printer 20 following the transmission of the file paths AP1 to AP10. In the present embodiment, a set of communications from the communication start notification SS to the communication end notification ES is defined as one (one-time) communication from the information terminal 30 to the printer 20. The terminal 30A that has received an issuance of the identification information ID1 attaches the identification information ID1 to communication to the printer 20 thereafter. The information terminal 30 repeats transmission of such one group of file paths, and thereby the information terminal 30 can transmit all the file paths to be transmitted (for example, 200 file paths) to the printer 20.

Here, as shown in FIG. 4, it is assumed that at a timing when the terminal 30A ends the transmission of the file paths AP1 to AP10, a communication start notification SS and file paths BP1 to BP10 are transmitted from the terminal 30B to the printer 20. Each of a set of file paths AP1 to AP10, a set of file paths BP1 to BP10, and a set of file paths BP11 to BP20 described later merely mean ten file paths. When the control unit 21 receives communication from the terminal 30B, the control unit 21 performs determination of step S120 through steps S100 and S110.

It is assumed that identification information is not attached to the communication start notification SS and the file paths BP1 to BP10 transmitted from the terminal 30B to the printer 20. Therefore, the control unit 21 performs determination of “No” in step S120 and proceeds to step S130. In this case, as described above, the identification information ID1 is issued to the terminal 30A, so that the control unit 21 determines “Yes” in step S130 and proceeds to step S150. In step S150, the control unit 21 invalidates the identification information ID1 issued to the terminal 30A and issues new identification information (identification information ID2) to the terminal 30B.

The terminal 30B transmits a communication end notification ES to the printer 20 following the transmission of the file paths BP1 to BP10. The terminal 30B that has received an issuance of the identification information ID2 attaches the identification information ID2 to communication to the printer 20 thereafter.

When identification information is attached to the communication detected in step S110 (“Yes” in step S120), the control unit 21 proceeds to step S160.

In step S160, the control unit 21 determines whether or not the identification information attached to the communication detected in step 110 is valid. The information terminal 30 may perform communication, to which identification information that was issued to the information terminal 30 and is currently invalidated is attached, to the printer 20. For example, a case is considered where in a state in which the identification information ID2 is issued, the terminal 30A performs communication, to which the identification information ID1 (invalidated identification information) is attached, to the printer 20. Therefore, the determination of step S160 is required.

When the control unit 21 determines that the identification information attached to the communication detected in step 110 is valid (“Yes” in step S160), the control unit 21 proceeds to step S170. On the other hand, when the control unit 21 determines that the identification information is invalid (“No” in step S160), the control unit 21 proceeds to step S190.

In step S190, the control unit 21 transmits a notification (an error notification) indicating that the communication is invalid to the transmission source of the communication detected in step S110. For example, in a state in which the valid identification information is the identification information ID2, when the terminal 30A performs communication, to which the identification information ID1 (invalidated identification information) is attached, to the printer 20, the control unit 21 sends an error notification to the terminal 30A as a response to the communication (step S190). The information terminal 30 that has received the error notification recognizes that the identification information attached to the communication to the printer 20 is already invalidated, and thereafter the information terminal 30 can prevent the identification information from being used. After step S190, the control unit 21 returns to step S100.

On the other hand, in step S170, the control unit 21 determines whether or not the communication detected in step S110 corresponds to final communication. The final communication is an execution request of predetermined processing based on data that have been transmitted. Here, the final communication corresponds to an execution request of printing processing (print execution instruction PRC (see FIG. 4)) to the printer 20. When the communication detected in step S110 corresponds to the final communication (“Yes” in step S170), the control unit 21 proceeds to step S180. On the other hand, when the communication detected in step S110 does not correspond to the final communication (“No” in step S170), the control unit 21 returns to step S100.

After the identification information ID2 is issued to the terminal 30B as described above, as shown in FIG. 4, the communication start notification SS, the file paths BP11 to BP20, and the communication end notification ES are transmitted from the terminal 30B to the printer 20. When the control unit 21 receives the communication from the terminal 30B, the control unit 21 performs determination of step S120 through steps S100 and S110. In this case, the identification information ID2 (currently valid identification information) is attached to the communication from the terminal 30B, so that “Yes” is determined in both steps S120 and S160, and determination of step S170 is performed. The file paths BP11 to BP20 received from the terminal 30B do not correspond to the final communication, so that the control unit 21 determines “No” in step S170 and waits for further communication.

Further, as shown in FIG. 4, the communication start notification SS, the print execution instruction PRC, and the communication end notification ES are transmitted from the terminal 30B to the printer 20. When the control unit 21 receives the communication from the terminal 30B, the control unit 21 performs determination of step S120 through steps S100 and S110. Also in this case, the identification information ID2 (currently valid identification information) is attached to the communication from the terminal 30B, so that “Yes” is determined in both steps S120 and S160, and determination of step S170 is performed. The print execution instruction PRC received from the terminal 30B corresponds to the final communication, so that the control unit 21 determines “Yes” in step S170 and proceeds to step S180.

In step S180, the control unit 21 performs printing processing based on file paths that have been received from a transmission source of the print execution instruction PRC according to the print execution instruction PRC. According to the example of FIG. 4, the control unit 21 has received the print execution instruction PRC from the terminal 30B. Therefore, the control unit 21 reads a plurality of image files indicated by each of a plurality of file paths BP1 to BP10 and BP11 to BP20 that have been received from the terminal 30B from the storage device 40 and prints the plurality of read image files. In this case, the control unit 21 appropriately perform resolution conversion, color conversion, halftone processing, and the like on the read image files to generate print data and causes the printing unit 26 to perform printing based on the generated print data.

Further, in step S180, the control unit 21 invalidates the identification information issued to the transmission source of the final communication. According to the example of FIG. 4, the control unit 21 invalidates the identification information ID2 issued to the terminal 30B which is the transmission source of the final communication (the print execution instruction PRC). Thereby, valid identification information disappears. After step S180, the control unit 21 returns to step S100.

### 4. Summary and the Other Description

As described above, according to the present embodiment, the control unit 21 of the printer 20 that performs wireless communication with the information terminal 30 functions as a communication control unit that receives first data when the first data (for example, the file paths AP1 to AP10) included in a first data group is transmitted from a first information terminal (for example, the terminal 30A) and receives second data when the second data (for example, the file paths BP1 to BP10) included in a second data group is transmitted from a second information terminal (for example, the terminal 30B), and also functions as a processing execution unit that can execute predetermined processing based on data received from the information terminal 30 according to an execution request of the predetermined processing received from the information terminal 30. The control unit 21 receives the second data when the control unit 21 detects transmission of the second data (for example, the file paths BP1 to BP10) included in the second data group from the second information terminal (for example, the terminal 30B) after receiving the first data (for example, the file paths AP1 to AP10) included in the first data group from the first information terminal (for example, the terminal 30A) before receiving an execution request of predetermined processing (the print execution instruction PRC) from the first information terminal, and executes predetermined processing (printing processing) based on the second data when the control unit 21 receives an execution request of predetermined processing (the print execution instruction PRC) from the second information terminal after receiving the second data before receiving data from an information terminal other than the second information terminal.

In wireless communication, it is well likely that the communication is interrupted by various causes (for example, battery exhaustion and moving out of a wirelessly communicable range) on the side of the information terminal 30 that communicates with the printer 20. For example, a case is considered where after the file paths AP1 to AP10 of one group are transmitted from the terminal 30A to the printer 20 as described above, file paths of the next one group and/or the print execution instruction PRC are not transmitted from the terminal 30A. On the other hand, when the printer 20 can wirelessly receive transmission of file paths and/or transmission of the print execution instruction PRC from a plurality of information terminals 30, the printer 20 responds to a request from an information terminal 30 that most recently started communication to the printer 20 in preference to requests from the other information terminals 30. Thereby, when data transmission from an information terminal 30 that started communication earlier is interrupted as described above, it is possible to reliably respond to a request from an information terminal 30 that started communication later than the above information terminal 30 without keeping the information terminal 30 that started communication later waiting.

In the present specification, the first information terminal and the second information terminal are information terminals included in a plurality of information terminals that can transmit data to the printing apparatus (the printer 20), and they are merely given names for distinguishing two information terminals that transmit data at different timings from each other. In FIG. 4, after the printer 20 receives the file paths BP1 to BP10 from the terminal 30B and before the printer 20 receives the print execution instruction PRC from the terminal 30B, if the printer 20 receives transmission of file paths from another information terminal 30 (an information terminal that does not have identification information) not shown in the drawings, the printer 20 shifts into a state for responding to a request from the other information terminal 30. When paying attention to relationship between the terminal 30B and the other information terminal 30, the terminal 30B corresponds to the first information terminal and the other information terminal 30 corresponds to the second information terminal. If the timing when the terminal 30A transmits the file paths AP1 to AP10 is later than the timing when the terminal 30B transmits the file paths BP1 to BP10 shown in FIG. 4, there may be a case in which the terminal 30B corresponds to the first information terminal and the terminal 30A corresponds to the second information terminal.

Further, according to the present embodiment, when the control unit 21 receives data from an information terminal 30, the control unit 21 issues identification information for identifying the transmission source of the data to the information terminal 30 of the transmission source and invalidates identification information that has been issued to another information terminal for identifying the other information terminal (step S150). When the control unit 21 receives an execution request (the print execution instruction PRC) from an information terminal 30 having identification information that has not been invalidated (“Yes” in step S170), the control unit 21 executes predetermined processing (printing processing) based on the data that has been received from the information terminal 30 having identification information that has not been invalidated (step S180). In this way, the control unit 21 gives valid identification information to only one information terminal 30 at that time as a communication partner that responds to a request, so that the control unit 21 can avoid confusion of printing processing based on data received from different transmission sources and appropriately perform printing processing corresponding to one transmission source.

It is assumed that the control unit 21 receives the print execution instruction PRC from the first information terminal (for example, the terminal 30A) after receiving the first data (for example, the file paths AP1 to AP10) from the first information terminal, and does not receive the second data (for example, the file paths BP1 to BP10) from the second information terminal (for example, the terminal 30B) between the reception of the first data and the reception of the print execution instruction PRC. Further, it is assumed that the control unit 21 does not receive data from an information terminal 30 other than the second information terminal (for example, the terminal 30B) between the reception of the first data and the reception of the print execution instruction PRC. In this case, the control unit 21 executes predetermined processing (printing processing) based on the first data according to the print execution instruction PRC from the first information terminal. Specifically, the control unit 21 reads an electronic file (an image file) specified by the first data (file path) received from the first information terminal from the storage device 40 and causes the printing unit 26 to print the read image file.

On the other hand, when the control unit 21 receives the second data (for example, the file paths BP1 to BP10) from the second information terminal (for example, the terminal 30B) after receiving the first data (for example, the file paths AP1 to AP10) from the first information terminal and before receiving the print execution instruction PRC from the first information terminal, the control unit 21 does not execute predetermined processing (printing processing) based on the first data (that is, the first data is defined as invalid data for the predetermined processing (printing processing)). More specifically, in step S150, the control unit 21 invalidates the identification information ID1 that has been issued to the terminal 30A and, when issuing new identification information ID2 to the transmission source (the terminal 30B) of the communication detected in step S110, discards data (the file paths AP1 to AP10), which has been received from the terminal 30A, because the data is not used for the printing processing. In other words, when the control unit 21 receives the second data from the second information terminal after receiving the first data from the first information terminal and before receiving the execution request (the print execution instruction PRC) from the first information terminal, the control unit 21 discards (deletes) the first data. Even if the print execution instruction PRC attached with the identification information ID1 (invalidated identification information) is transmitted from the terminal 30A after issuing the identification information ID2 to the terminal 30B as described above, the control unit 21 determines “No” for the print execution instruction PRC from the terminal 30A in step S160. Thereby, the printer 20 can avoid mix-up between data received from different transmission sources and confusion of printing processing based on data received from different transmission sources, so that the printer 20 can appropriately perform printing processing corresponding to one transmission source (in this case, the terminal 30B).

When the control unit 21 performs error notification in step S190 to the information terminal 30 that that has sent communication attached with invalid identification information, the control unit 21 discards data (file path) transmitted by the communication attached with the invalid notification information because the data is not used for printing processing.

Further, in the present embodiment, in response to executing the predetermined processing (printing processing) based on the data that has been received from the information terminal 30 having identification information that has not been invalidated, the control unit 21 invalidates the identification information (step S180). Thereby, the printer 20 restores the state where there is no valid identification information, and waits for data transmission from the information terminal 30 again.

When the control unit 21 has invalidated the identification information in step S150 and/or step S180, the control unit 21 may notify the information terminal 30 that has been attached with the invalidated identification information that the identification information has been invalidated. By this notification, it is possible to prevent the information terminal 30 from performing communication, to which identification information that has been invalidated is attached, to the printer 20.

As described above, when the control unit 21 invalidates identification information that has been issued to an information terminal 30 in step S150, the control unit 21 also discards data that has been received from the information terminal 30. After discarding such data that has been received (that is, after step S150), the control unit 21 may transmit a predetermined screen display instruction to the information terminal 30 that is the transmission source of the discarded data in parallel with the flowchart of FIG. 3. As described in FIG. 4, in response to receiving the transmission of the file paths BP1 to BP10 from the terminal 30B, the control unit 21 invalidates the identification information ID1 that has been issued to the terminal 30A in step S150 and issues the identification information ID2 to the terminal 30B. Then, after discarding the file paths AP1 to AP10 that have been received from the terminal 30A, the control unit 21 transmits a screen display instruction DC to the terminal 30A.

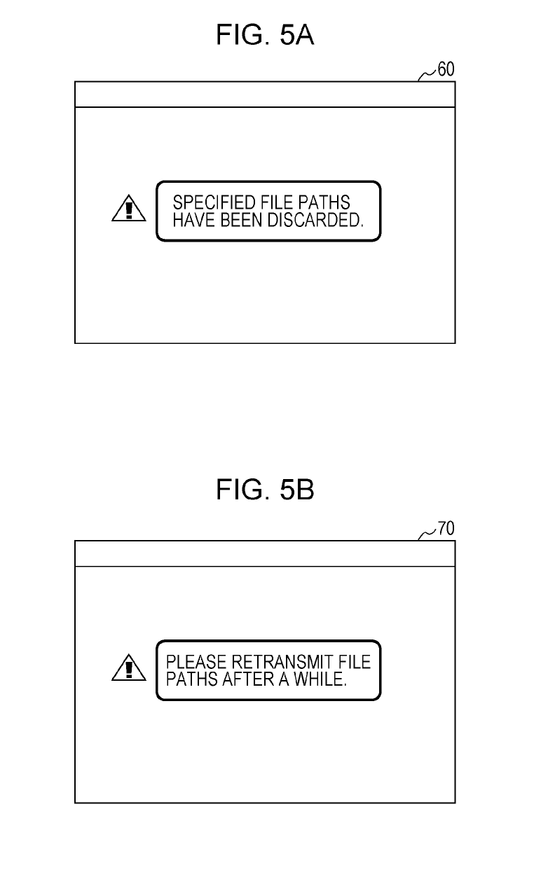

Each of FIGS. 5A and 5B shows a specific example of an alert screen displayed on the information terminal 30 by the screen display instruction DC. An alert screen 60 shown in FIG. 5A includes a message such as, for example, “SPECIFIED FILE PATHS HAVE BEEN DISCARDED.”. The information terminal 30 that receives the screen display instruction DC from the printer 20 causes the display unit 33 to display such an alert screen 60. A user who sees the alert screen 60 through the display unit 33 can recognize that the file paths which the user indicates to the printer 20 by operating the information terminal 30 have been discarded, that is, printing of each image file which the user has selected through the file selection screen 50 (FIG. 2) is not performed and is invalidated.

An alert screen 70 shown in FIG. 5B includes a message such as, for example, “PLEASE RETRANSMIT FILE PATHS AFTER A WHILE.”. The information terminal 30 that receives the screen display instruction DC from the printer 20 may cause the display unit 33 to display such an alert screen 70. A user who sees the alert screen 70 through the display unit 33 can recognize that the user should redo an operation to instruct the printer 20 to print each image file which the user has selected through the file selection screen 50 (FIG. 2), that is, an operation to transmit a plurality of file paths (a data group) to the printer 20.

The alert screen 60 is a specific example of a screen display indicating that the data has been discarded, and the alert screen 70 is a specific example of a screen display prompting retransmission of the data. According to such a configuration, it can be said that the control unit 21 transmits a predetermined screen display instruction to the first information terminal after discarding the first data, and thereby the control unit 21 causes the first information terminal to perform at least either one of a screen display indicating that the first data is discarded and a screen display prompting retransmission of the first data. In the alert screen 70, a timing of performing retransmission of data may be specifically notified to the user (for example, such as “Please retransmit file paths after 30 minutes.”). The screen display instruction DC transmitted by the control unit 21 may be an instruction to cause an information terminal 30 of the transmission destination of the instruction to display only one of the alert screens 60 and 70 or may be an instruction to cause the information terminal 30 to display both the alert screens 60 and 70 (for example, to display the alert screens 60 and 70 continuously). Further, when the control unit 21 transmits an error notification in step S190, the control unit 21 may transmit the screen display instruction DC along with the error notification to the transmission destination of the error notification.

The control unit 21 may execute the predetermined processing (printing processing) based on the data that has been received from the information terminal 30 having identification information that has not been invalidated in step S180, and after invalidating the identification information, the control unit 21 may transmit a predetermined data retransmission instruction to the information terminal 30 whose identification information has been invalidated in step S150 in the past in parallel with the flowchart of FIG. 3. As described in FIG. 4, in response to receiving the print execution instruction PRC from the terminal 30B, the control unit 21 executes printing processing based on the file paths received from the terminal 30B in step S180, and after invalidating the identification information ID2 that has been issued to the terminal 30B, the control unit 21 transmits data retransmission instruction RSC to the terminal 30A having the identification information ID1 that is invalidated in step S150 before invalidating the identification information ID2.

The information terminal 30 that receives the data retransmission instruction RSC from the printer 20 transmits file paths (data group) of each image file that was selected and stored by a user through the file selection screen 50 (FIG. 2) in the past to the printer 20. At this time, the information terminal 30 also transmits file paths (a group of file paths) that have already been transmitted. According to such a configuration, it can be said that the control unit 21 executes the predetermined processing (printing processing) based on the second data, and thereafter causes the first information terminal to perform retransmission of the first data by transmitting a retransmission instruction (the data retransmission instruction RSC) of the first data to the first information terminal. The terminal 30A that receives the data retransmission instruction RSC (FIG. 4) starts transmission of file paths of each group in a plurality of file paths (data groups) from an initial group (that is, from transmission of the file paths AP1 to AP10). As a result, the printer 20 can perform printing processing based on a plurality of file paths (data groups) transmitted from the terminal 30A.

Each of the transmission of the screen display instruction DC and the transmission of the data retransmission instruction RSC by the printer 20 described above is an option included in the present embodiment. It can be said that it is basically sufficient to perform either one of the transmission of the screen display instruction DC and the transmission of the data retransmission instruction RSC when considering effects of these. However, the present embodiment does not particularly prevent the printer 20 from transmitting the screen display instruction DC and the data retransmission instruction RSC at each timing to the same information terminal 30.

Further, in the present embodiment, when the information terminal 30 transmits a plurality of file paths respectively indicating storage locations of a plurality of selected electronic files to the printer 20, the information terminal 30 divides the plurality of file paths into a plurality of groups and transmits file paths of one group to the printer 20 for each communication of a plurality of times of communication. Thereby, it is prevented that one information terminal 30 occupies wireless communication with the printer 20, so that another information terminal 30 is not made to wait for a long time until starting communication with the printer 20.

Hitherto, an embodiment is described in which the information terminal 30 divides a plurality of file paths (data group) into groups each of which has a predetermined number of file paths, and transmits the file paths to the printer 20 in a group unit. However, in the present embodiment, for example, the information terminal 30 may divide image files held by the information terminal 30 itself into a plurality of data and transmit the plurality of divided data to the printer 20 by a plurality of times of communication.

The execution request of predetermined processing from the information terminal 30 to the printer 20 is not limited to the execution request of printing processing (the print execution instruction PRC), but may be, for example, a copy (transfer) request of image files. Specifically, the information terminal 30 transmits a plurality of file paths to the printer 20 by a plurality of times of transmission as described above and thereafter transmits a copy request of image files to the printer 20. The printer 20 determines the received copy request as the final communication (step S170), and in step S180, the printer 20 copies image files indicated by file paths that have been received from the information terminal 30 of the transmission source of the copy request from the storage device 40 to another storage apparatus (a storage apparatus wiredly or wirelessly connected to the printer 20) according to the copy request.

If the predetermined processing is not the printing processing in this way, the processing described as processing executed by the printer 20 may be executed by an information processing apparatus (an apparatus that does not have a printing function) other than printer.

The storage device 40 is not limited to a storage apparatus externally connected to the printer 20, but may be a storage apparatus built in the printer 20 (a storage apparatus connected to the printer 20 inside the printer 20).

### 5. Second Embodiment

The embodiment described above is also called a first embodiment. Hereinafter, a second embodiment of the invention will be described. In the second embodiment, items common to the first embodiment will be appropriately omitted.

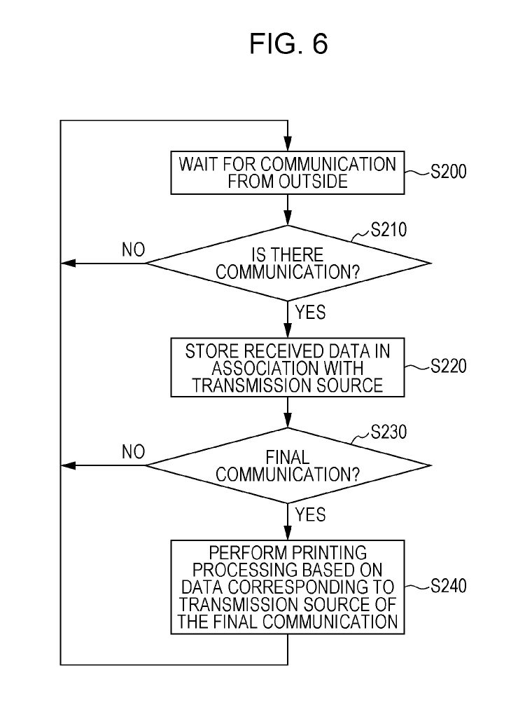

FIG. 6 shows wireless printing processing according to the second embodiment, which the control unit 21 of the printer 20 realizes according to the wireless printing execution program 27, by using a flowchart. In the second embodiment, the control unit 21 functions as a communication control unit, a data holding unit, and a processing execution unit by executing processing according to the wireless printing execution program 27.

Processing of steps S200 and S210 is basically the same as that of steps S100 and S110 (FIG. 3) of the first embodiment. When there is wireless communication from outside (“Yes” in step S210), the control unit 21 proceeds to step S220.

In step S220, the control unit 21 stores data transmitted by the communication detected in step S210, that is, data received from the information terminal 30, into a predetermined memory (for example, RAM 21c) in association with the information terminal 30 that is the transmission source of the data. It can be said that the predetermined memory (for example, RAM 21c) functions as a part of the data holding unit.

Also in the second embodiment, it is assumed that the file paths of one group as described above are transmitted from the terminals 30A and 30B, each of which corresponds to the information terminal 30, to the printer 20. For example, as shown in FIG. 4, when the file paths AP1 to AP10 are transmitted from the terminal 30A following the communication start notification SS, the control unit 21 stores the file paths AP1 to AP10 received from the terminal 30A in association with the terminal 30A which is the transmission source. To store the file paths AP1 to AP10 in association with the information terminal 30 of the transmission source means to store the file paths AP1 to AP10 in association with information (serial number or the like) unique to the information terminal 30 of the transmission source. Thereafter, as illustrated in FIG. 4, when the file paths BP1 to BP10 are transmitted from the terminal 30B following the communication start notification SS, the control unit 21 stores the file paths BP1 to BP10 received from the terminal 30B in association with the terminal 30B which is the transmission source. Thereafter, as illustrated in FIG. 4, when the file paths BP11 to BP20 are transmitted from the terminal 30B following the communication start notification SS, the control unit 21 stores the file paths BP11 to BP20 received from the terminal 30B in association with the terminal 30B which is the transmission source (step S220).

Also in the first embodiment, it is described that when the printer 20 receives data (file paths or the like) transmitted from the information terminal 30 following the communication start notification SS, the printer 20 stores the data. Of course, in the first embodiment, the printer 20 stores the received data in a state in which a one-to-one correspondence relationship between the data and the information terminal 30 of the transmission source is known. However, in the first embodiment, when the printer 20 discards data received so far from the information terminal 30 having identification information invalidated in step S150 at a timing of step S150 or discards data attached with invalidated identification information, which is received from the information terminal 30 of a transmission destination of an error notification, when performing error notification in step S190. On the other hand, in the second embodiment, such data are not discarded. Therefore, the second embodiment does not require steps (steps S130, S140, and S150) for issuing valid identification information to an information terminal 30 (the second information terminal) that starts communication after an information terminal 30 (the first information terminal) starts communication and steps (steps S120 and S160) for determining whether or not the information terminal 30 of a communication partner has valid identification information, which are described in the first embodiment.

In step S230, the control unit 21 performs the same determination as that of step S170 of the first embodiment. Specifically, the control unit 21 determines whether or not the communication detected in step S210 corresponds to final communication. As described above, the final communication is an execution request of printing processing (the print execution instruction PRC) to the printer 20. When the communication detected in step S210 corresponds to the final communication (“Yes” in step S230), the control unit 21 proceeds to step S240. On the other hand, when the communication detected in step S210 does not correspond to the final communication (“No” in step S230), the control unit 21 returns to step S200.

In step S240, the control unit 21 performs printing processing based on file paths that have been received from the transmission source of the final communication (the print execution instruction PRC) according to the communication detected in step S210, and thereafter returns to step S200. For example, the control unit 21 receives the print execution instruction PRC from the terminal 30B (“Yes” in step S210 and step S230). In this case, the control unit 21 reads a plurality of image files respectively indicated by a plurality of file paths that have been received from the terminal 30B, that is, a plurality of file paths that have been stored in a predetermined memory in association with the terminal 30B, from the storage device 40, and prints the plurality of read image files (step S240). Further, the control unit 21 receives the print execution instruction PRC from the terminal 30A while repeating the flowchart of FIG. 6 after receiving the print execution instruction PRC from the terminal 30B and performing step S240 (“Yes” in step S210 and step S230). In this case, the control unit 21 reads a plurality of image files respectively indicated by a plurality of file paths that have been received from the terminal 30A, that is, a plurality of file paths that have been stored in a predetermined memory in association with the terminal 30A, from the storage device 40, and prints the plurality of read image files (step S240).

According to the second embodiment as described above, the control unit 21 of the printer 20 functions as a communication control unit that receives the first data when the first data (for example, the file paths AP1 to AP10) included in the first data group is transmitted from the first information terminal (for example, the terminal 30A) and receives the second data when the second data (for example, the file paths BP1 to BP10) included in the second data group is transmitted from the second information terminal (for example, the terminal 30B), functions as a data holding unit that holds the first data received from the first information terminal in association with the first information terminal and holds the second data received from the second information terminal in association with the second information terminal, and further functions as a processing execution unit that can execute predetermined processing based on the held data (data stored in a predetermined memory). Then, the control unit 21 executes predetermined processing based on data held in association with the information terminal 30 in order from the information terminal 30 which sends the final communication (transmits the print execution instruction PRC), that is, the information terminal 30 which has transmitted all data (all groups of file paths) included in a data group (a plurality of file paths). Therefore, when data transmission from an information terminal 30 (the first information terminal) is stopped or interrupted, data transmission from another information terminal 30 (the second information terminal) is received by the printer 20 without delay, and predetermined processing according to the communication from the second information terminal is smoothly advanced. In addition, when the data transmission from the first information terminal, which is stopped or interrupted, is resumed, the printer 20 does not discard but holds data that has been so far received from the first information terminal, so that the printer 20 can smoothly execute predetermined processing according to the communication from the first information terminal. Further, the printer 20 holds data received from each information terminal 30 in association with the information terminal 30 of the transmission source of the data, so that even when the printer 20 receives the final communication (transmission of the print execution instruction PRC) from any information terminal 30, the printer 20 can execute appropriate printing processing according to the print execution instruction PRC without mix-up of data.

In the second embodiment, it is possible to further employ configurations as described below.

In the second embodiment, the printer 20 does not discard but holds data received from the information terminal 30 until using the data for printing processing according to the final communication (transmission of the print execution instruction PRC) from the information terminal 30. Therefore, a device to hold a large amount of data is required. Therefore, the control unit 21 may cause the storage device 40 connected to the printer 20 to store at least a part of data to be held by a predetermined memory as described above when a predetermined condition is established.

As the predetermined condition, for example, the conditions 1 and 2 described below are considered.

Condition 1: A total data size of data (file paths) received from each information terminal 30 exceeds a predetermined threshold value (first threshold value) related to a storage capacity of a predetermined memory (for example, RAM 21c). Here, the storage capacity of the predetermined memory>the first threshold value.

Condition 2: The number of information terminals 30 that are continuing transmission processing of each data (file paths of one group) included in a data group (a plurality of file paths) exceeds a predetermined threshold value (second threshold value) related to the number of information terminals.

The information terminal 30 that is continuing transmission processing in the condition 2 means an information terminal 30 where the control unit 21 has received and held at least a part of data (file paths) and has not yet received the final communication (transmission of the print execution instruction PRC).

When at least either one of the conditions 1 and 2 is established, the control unit 21 transfers a part of data (file paths) that is currently stored in a predetermined memory (for example, RAM 21c) to the storage device 40 and causes the storage device 40 to store the part of data. When the control unit 21 receives the final communication (transmission of the print execution instruction PRC) from an information terminal 30, the control unit 21 reads data (file paths) stored in association with the information terminal 30 from the predetermined memory and the storage device 40 and uses the data (file paths) for printing processing. According to such a configuration, the printer 20 can avoid in advance a situation where data transmitted from each information terminal to a memory in the printer 20 cannot be held any more, and hold data in the memory and the storage device 40 connected to the printer 20 in a distributed manner.

In a state in which the control unit 21 stores data (file paths) received from an information terminal 30 into a predetermined memory (for example, RAM 21c) and the storage device 40 in a distributed manner as described above, when the control unit 21 detects that the storage device 40 is detached from the IF 23 (FIG. 1) of the printer 20, the control unit 21 discards the data (file paths) stored in the memory in association with the information terminal 30. This is because in a situation where it is unknown whether or not the storage device 40 that stores a part of file paths associated with an information terminal 30 will be attached to the printer 20 again, holding continuously the remaining file paths associated with the information terminal 30 in the control unit 21 is highly probable to be a waste of memory resources.

Further, when the control unit 21 detects that the storage device 40 is attached to the IF 23 of the printer 20, the control unit 21 deletes data (file paths) as one of initialization operations on the storage device 40. In other words, when file paths that are transmitted from an information terminal 30 and stored in association with the information terminal 30 remain in the storage device 40 attached to the printer 20, the control unit 21 deletes the remaining file paths.

The entire disclosure of Japanese Patent Application No. 2017-051772, filed Mar. 16, 2017 and No. 2017-221644, filed November 17th is expressly incorporated by reference herein.

What is claimed is:

1. A printing apparatus that performs wireless communication with an information terminal, the printing apparatus comprising:
a communication control unit that receives first data when the first data included in a first data group is transmitted from a first information terminal and receives second data when the second data included in a second data group is transmitted from a second information terminal; and
a processing execution unit that can execute predetermined processing based on data received by the communication control unit according to an execution request of the predetermined processing received by the communication control unit,
wherein the processing execution unit
executes the predetermined processing based on the first data when the communication control unit receives the execution request from the first information terminal after receiving the first data from the first information terminal and before receiving data from an information terminal other than the first information terminal, and
does not execute the predetermined processing based on the first data when the communication control unit receives the second data from the second information terminal after receiving the first data from the first information terminal and before receiving the execution request from the first information terminal, and thereafter executes the predetermined processing based on the second data when the communication control unit receives the execution request from the second information terminal before receiving data from an information terminal other than the second information terminal.

2. The printing apparatus according to claim 1, wherein
the communication control unit receives data that specifies an electronic file stored in a storage apparatus connected to the printing apparatus as each of the first data and the second data.

3. The printing apparatus according to claim 2, wherein
the execution request of the predetermined processing is an execution request of printing processing, and
the processing execution unit executes printing of the electronic file specified by the first data as the predetermined processing based on the first data and executes printing of the electronic file specified by the second data as the predetermined processing based on the second data.

4. The printing apparatus according to claim 1, wherein
when the communication control unit receives data from the information terminal, the communication control unit issues identification information for identifying a transmission source of the data to the information terminal of the transmission source and invalidates identification information that has been issued to another information terminal to identify the other information terminal, and
when the processing execution unit receives the execution request from the information terminal having the identification information that is not invalidated, the processing execution unit executes the predetermined processing based on data that has been received from the information terminal having the identification information that is not invalidated.

5. The printing apparatus according to claim 4, wherein
the processing execution unit executes the predetermined processing based on data that has been received from the information terminal having the identification information that is not invalidated, and accordingly, the communication control unit invalidates the identification information.

6. The printing apparatus according to claim 1, wherein
when the communication control unit receives the second data from the second information terminal after receiving the first data from the first information terminal and before receiving the execution request from the first information terminal, the processing execution unit discards the first data.

7. The printing apparatus according to claim 6, wherein
after discarding the first data, the communication control unit causes the first information terminal to execute at least either one of a screen display indicating that the first data is discarded and a screen display that prompts retransmission of the first data by transmitting a predetermined screen display instruction to the first information terminal.

8. The printing apparatus according to claim 6, wherein
after the processing execution unit executes the predetermined processing based on the second data, the communication control unit causes the first information terminal to execute retransmission of the first data by transmitting a retransmission instruction of the first data to the first information terminal.

9. A printing apparatus that performs wireless communication with an information terminal, the printing apparatus comprising:
a communication control unit that receives first data when the first data included in a first data group is transmitted from a first information terminal and receives second data when the second data included in a second data group is transmitted from a second information terminal;
a data holding unit that holds the first data, which the communication control unit receives from the first information terminal, in association with the first information terminal, and holds the second data, which the communication control unit receives from the second information terminal, in association with the second information terminal; and
a processing execution unit that can execute predetermined processing based on data held by the data holding unit,
wherein the processing execution unit executes the predetermined processing based on data held in association with an information terminal in order from the information terminal that has transmitted all data included in a data group.

10. The printing apparatus according to claim 9, wherein
when a predetermined condition is established, the data holding unit causes a storage apparatus connected to the printing apparatus to store at least a part of the data held by the data holding unit.

11. The printing apparatus according to claim 10, wherein
the data holding unit determines that the predetermined condition is established when a total data size of data which the communication control unit receives from an information terminal exceeds a predetermined threshold value related to a storage capacity of the data holding unit or when the number of information terminals that are continuing transmission processing of each data included in a data group exceeds a predetermined threshold value related to the number of information terminals.
